(19) United States
(12) Patent Application Publication
(10) Pub. No.: US 2023/0115753 A1
(43) Pub. Date: Apr. 13, 2023

(54) Heated Panel Valley End Cap

(71) Applicant: Eric L Wimmer, Ogden, UT (US)

(72) Inventor: Eric L Wimmer, Ogden, UT (US)

(21) Appl. No.: 18/065,382

(22) Filed: Dec. 13, 2022

Related U.S. Application Data
(63) Continuation-in-part of application No. 16/245,956, filed on Jan. 11, 2019, now Pat. No. 11,525,266.
(60) Provisional application No. 62/616,998, filed on Jan. 12, 2018.

(51) Int. Cl. E04D 13/10

(52) U.S. Cl. CPC E04D 13/103; H05B 2214/02; H05B 3/56

(57) ABSTRACT

A snow and ice melt system for a roof may feature heat plates which protect and contact heat cable to distribute heat over a wider area than cable alone. Specially tailored ends in the plates create attachment structures by which the plates are assembled, and by which heat cable is contained. Specially formed caps cover roof valley locations with specially engineered folds and channels tailored to protect the cable in these valley locations and allow heat panel stacking and interlocking to cover an entire roof.

### CROSS-REFERENCES TO RELATED APPLICATIONS

This Application is a Continuation in Part of U.S. Nonprovisional Utility patent application Ser. No. 16/245,956 filed Jan. 11, 2019, now U.S. Pat. No 11,525,266 issued Dec. 13, 2022, and incorporates the same by reference herein in its entirety. This Application therefore also claims priority to initially filed U.S. Provisional Utility Application No. 62/616,998, filed Jan. 12, 2018, and incorporates the same by reference herein in its entirety.

### FIELD OF THE INVENTION

The present invention relates to a Roof Snowmelt Cap Plate system which distributes heat in a manner to melt snow accumulation on a rooftop. The herein-disclosed invention further relates to methods of covering and heating the “Valley of a Roof Plane,” the roof position where heated panel endpoints need a concealed cap to house, cover and stabilize a heat cable.

### BACKGROUND OF THE INVENTION

In colder climates, winter typically brings precipitation in the form of snow. Unlike rain, which maintains its fluid nature and seeks the ground when it lands on a structure, snow accumulates on a structure until it melts. Sometimes, this pattern creates problems as rain gutters and downspouts may clog with snow and prevent proper drainage. Typically, this pattern occurs when snow accumulates by the edge of the roof, over or near the gutter, and then freezes into a more solid block of ice. When this phenomenon occurs, snow can melt behind this ice dam and form a pool of water on the roof itself. This will damage the shingle and roof surface and can cause significant damage to a building's roof.

One method of preventing this occurrence is to place heating cables along the roof line. Heating cables are typically a high voltage and high resistance cable which generates heat when activated. This heat melts snow and any ice forming along the roof line and keeps the gutters and area around them clear. Usually, when snow is melted in this fashion, it does not tend to refreeze while it is drained off the roof.

However, these cables are exposed on the roof and are usually deployed in a tight serpentine pattern as air does not conduct heat well and much of the thermal energy generated by the cable is lost as distance from it increases. As they are exposed, they can face potential damage from the elements over the course of a year. As they are tightly serpentine in their deployment, a large length of cable is usually required for a short span of roof. A new apparatus which can not only protect the cable but also lessen the length of cable needed to adequately protect a roof surface would be a benefit to the industry.

The present invention is a plating apparatus which not only secures cables to the roof, but also evenly distributes heat from the cables to a much further distance away from the cable than the cable can conduct alone. As such, less cable is needed for effective snow and ice melting and the cable remains protected throughout the year.

The present invention represents a departure from the prior art in that the system of the present invention provides a plate structure which is easily assembled and installed on a roof which also protects the cables and efficiently distributes heat from said cables in a manner which greatly lessens the length of cable needed to adequately protect a roof.

Regarding the herein-disclosed Valley Cap system, the Valley roof locations require that the Cable be positioned under a plate. As the cable transitions to the upper plate, it must tuck into a cavity through which the heat-cable runs.

This requirement requires a substantially diagonal-slot-cut on the top side of the plate to allow the heat-cable to pass from underneath the plate to transition over the upper end of the top portion of the plate.

The Valley locations also create a directional push from the opposite roof plane. This situation creates the need for an anchor at or near the valley location. The plate must attach to a valley-location fixture so it can withstand the directional push from the opposite roof plane. This circumstance requires a folded-insertion-lip that hooks to a cleat or s-bend.

The side of the plate opposite of the valley must also have either a vertical slot or similar appropriate feature to allow for snow to slide downward without catching the edge of the plate.

In addition, there are limitations to the size of pockets and cavities that can be created. Also, the insertion lip for the valley often requires “form-fitting” to a possible cleat or s-bend on the valley. Adjustments must account for the pitch of the roof. When the pitch of the roof changes, the valley angle changes. This means each cap plate would ordinarily need to be fabricated/tailored to the pitch of the roof.

The resulting system needs to allow the cable to transition from under the plate to a position over the top of the plate into a new cavity of the heated panel such that every edge of the plate would be sufficiently counter flushed by a material above it. The instant invention then protects against snow and ice sliding from above the system.

### SUMMARY OF THE INVENTION

An improved snow melt system providing a protective plate which anchors and contacts a snow melt cable to evenly distribute heat. Such a system meets the following objectives: cost effective in its construction; easily-installed, adequately protects heating cables during their useful lifetime; allows said cables to be replaced at the end of their useful lifetime; accommodates various cable sizes; and efficiently distributes heat from the cables in a manner that effectively melts snow and ice from along a roof line As such, the new and improved snow melt system may comprise a plurality of metallic plates configured to support the cables and to clip together and to be secured under roofing shingles in order to accomplish these objectives.

With specific regard to the roof valley position, the herein-disclosed invention comprises, inter alia, at least one specially formed plate that mounts to the heated panel where it intersects with a valley position on a roof system.

The heat cable is inserted into the heated panels at roof valley locations. The heat cable transitions from one horizontal heated-cavity (inside the panel) to another horizontal heated-cavity (inside the panel), all the while exposed areas are covered by “valley caps.” At the transition point, the Valley Cap is placed over the top of the heat cable's transition position.

In some embodiments, the top side of the end cap slides into the cavity of the channel containing the heat cable. The side of the cap that intersects with the valley has an insertion lip that hooks into an s-style-fold to hold the plate to the valley.

There is also a small fold on the bottom side of the plate that hooks to the lower edge of the heated panel. At this position-point, optional screws are placed to secure the panel to the roof. An optional additional end cap is then placed over the first end cap, therein integrating the edges of the plate to the heated panels and valley.

The more notable features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in several ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

FIG. 1 is a perspective view of a snow-covered roof, with an exemplary snow melt system partially installed.

FIG. 2 is a perspective view of the snow melt system utilized in FIG. 1.

FIG. 3 is a close-up view of the snow melt system of FIG. 2, taken in circle III.

FIG. 4 is a perspective view of the drip edge cover utilized in the snow melt system of FIG. 1

FIG. 5 is a perspective view of the middle plate utilized in the snow melt system of FIG. 1.

FIG. 6 is a side elevation of the drip edge cover of FIG. 4 and middle plate of FIG. 5 joined, with a heating cable.

FIG. 7 is a perspective view of the terminal plate utilized in the snow melt system of FIG. 1.

FIG. 8 is a side elevation of the terminal plate of FIG. 7 and middle plate of FIG. 5 joined, with a heating cable.

FIG. 9 is a close-up view of the snow melt system of FIG. 1, taking in circle IX, detailing its interface with the roof shingles.

FIG. 10 is a perspective view of a snow-covered roof, with an alternate snow melt system partially installed.

FIG. 11 is a perspective view of a snow-covered roof, with a further alternate snow melt system partially installed;

FIG. 12 is an aerial view of a roof valley location,

FIG. 13 is a front perspective view of the herein-disclosed invention substantially covering a roof valley location.

FIG. 14 is a top view of the specialized six-sided valley cap plate;

FIG. 15 is a top view of the heated panel system with cable exposed (without plates);

FIG. 16 is a top view of the Valley Cap plate covering the heat cable on panel 1;

FIG. 17 is a top view of Valley Cap Plate Two Being attached over the previous cap plate (cap plate one);

FIG. 18 is a top view illustrating Completion [“as assembled”] Cap Plate Two Locked over Cap Plate One and attached to Heat Panels, therein Concealing and Protecting the Cable.

FIG. 19 is an aerial perspective view of the invention “as assembled” illustrating the invention panels over a roof valley location, with the panels both “stacked” vertically as well as horizontally abutting/neighboring, showing how the panels may cover an irregular roof valley location.

### DETAILED DESCRIPTION

With reference now to the drawings, a preferred embodiment of the snow melt system is herein described. It should be noted that the articles “a,” “an,” and “the,” as used in this specification, include plural referents unless the content clearly dictates otherwise.

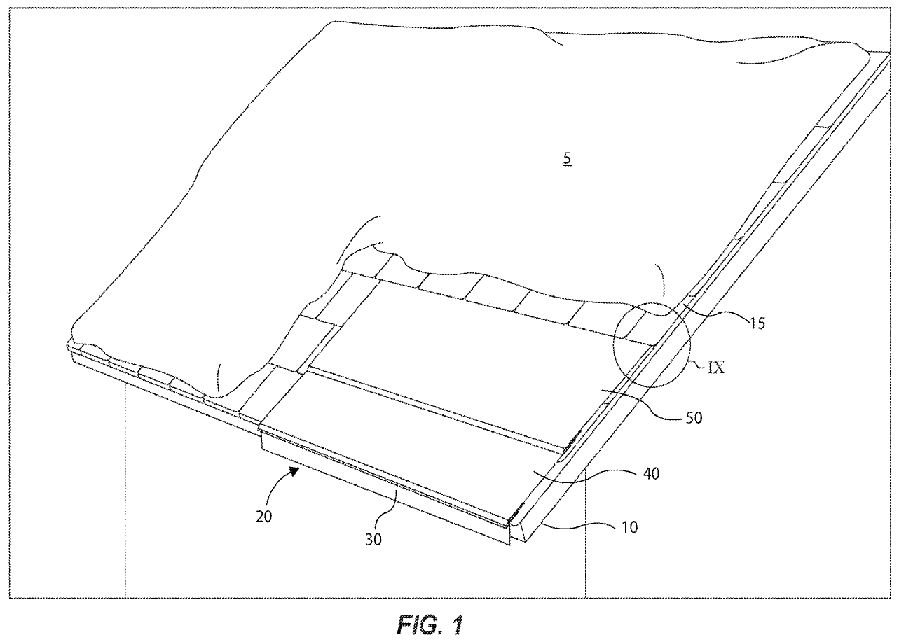

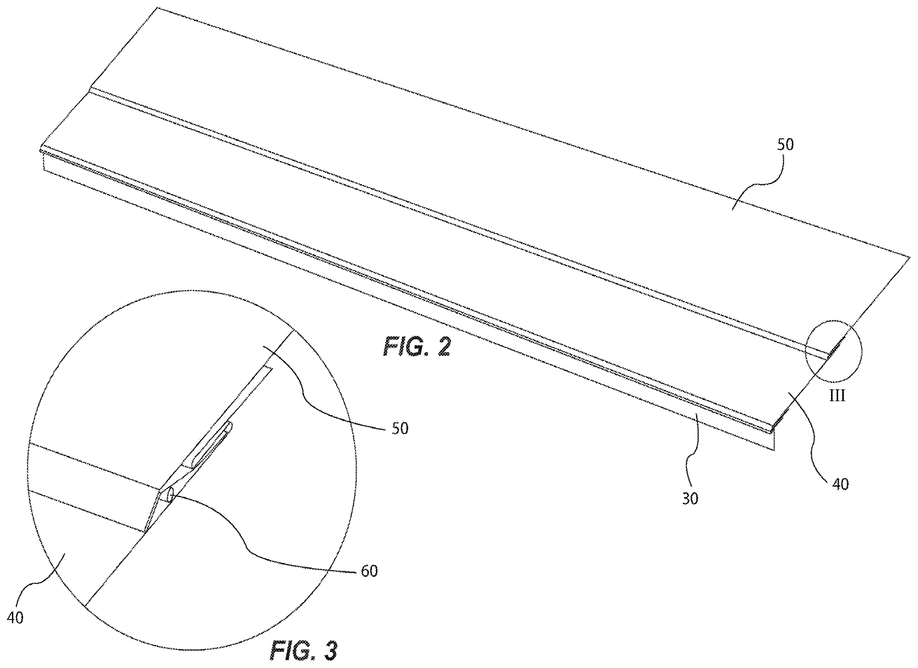

With reference to FIG. 1, a snow-covered roof 10 is depicted, with one side utilizing an exemplary embodiment of the snow melt system 20. The side of the roof without the system remains covered in snow 5, while the snow melt system 20 effectively melts snow near the edge of the roof 10. The depicted snow melt system 20 (FIGS. 2 and 3) features four components: a drip edge cover 30, a middle plate 40, a terminal plate 50 and a heat cable 60.

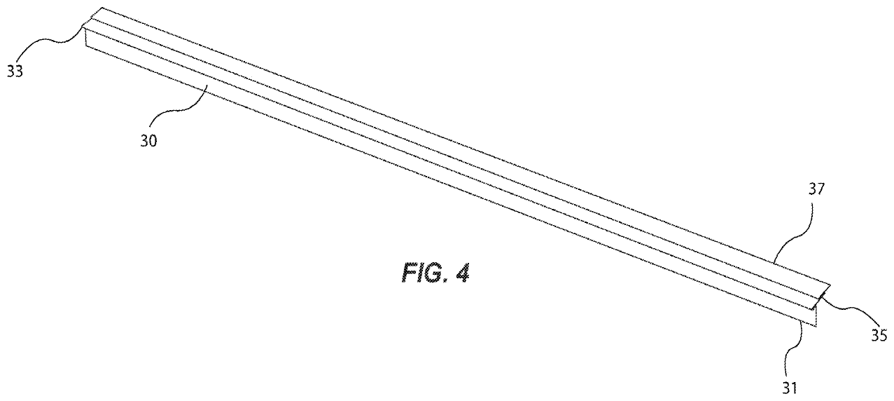

Drip edge cover 30 (FIG. 4) is a rectangular plate which has been bent to accommodate the edge of the roof. Its upper longitudinal edge 37 serves as an attachment, or anchor, strip and may be attached to the roof by any known or later discovered roof attachment means, including nails, staples, or glue and other adhesives. An S-bend 35 is located slightly beneath the anchor strip 37. The cover is then folded over itself slightly, creating a protrusion, or cable platform 33, before it angles downward at an approximately right angle and terminates at is lower edge 31. The protrusion provides a flat surface for interacting with the heat cable and next successive plate, which in the depicted embodiment is the middle plate 40.

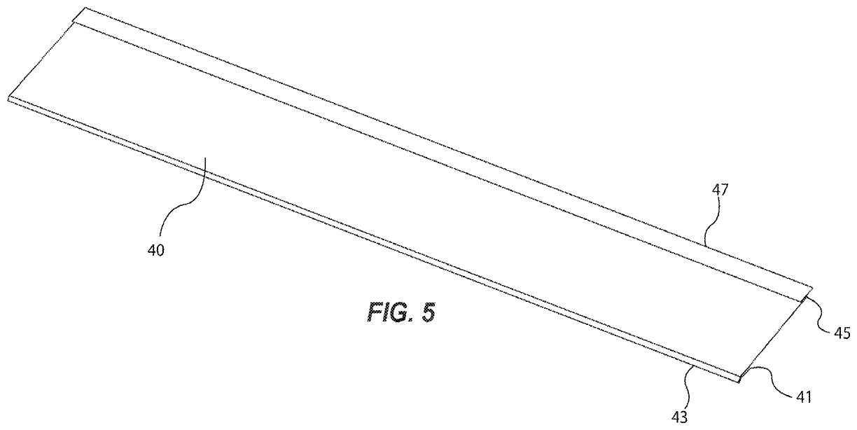

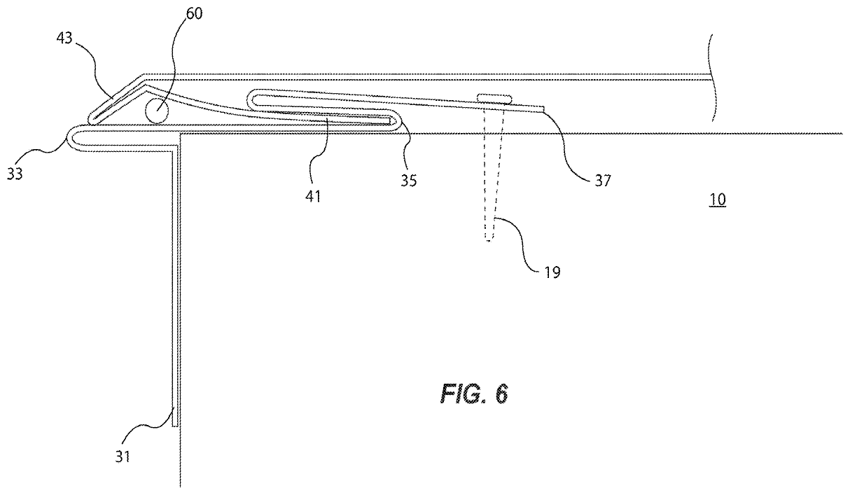

The middle plate 40 (FIG. 5) is essentially rectangular with two longitudinal edges. As with the drip edge cover, upper edge 47 serves as an anchor strip and may be fastened to the roof. Proximate the upper edge 47 is an S-bend 45 like that of the drip edge cover 30. The lower edge is folded over itself and bent in a slight V-bend to form a cable containment lip 43 while the edge itself 41 becomes an insert for the drip edge cover's S-bend 35. The interaction of these pieces is shown in FIG. 6. The lower edge 41 of the middle plate 40 is fitted into the S-bend 35 of the drip edge cover 30. The containment lip 43 and cable platform 33 combine to form a chamber in which cable 60 may reside. It is ideal that the cable 60 be wedged into the chamber and maximize its contact with both the drip edge cover 30 and middle cover 40 to promote thermal conduction. The middle plate 40 then covers the remainder of the drip edge cover 30, including the attachment strip 37. This arrangement prevents water from interacting with the roof attachment means.

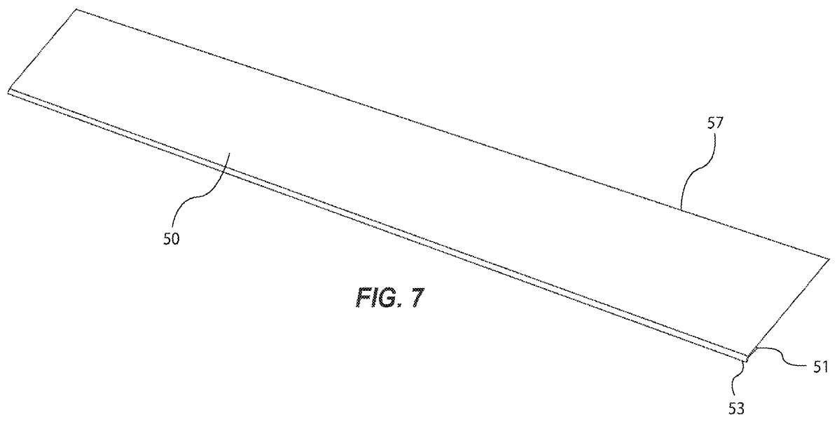

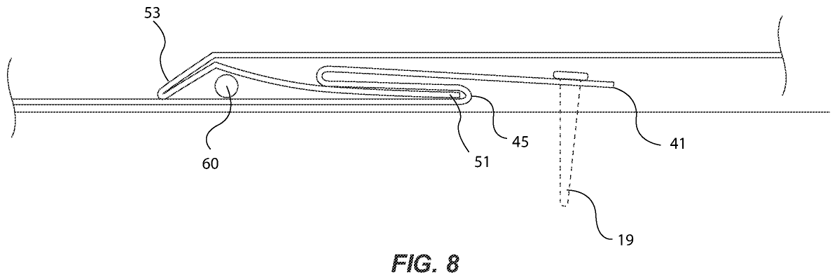

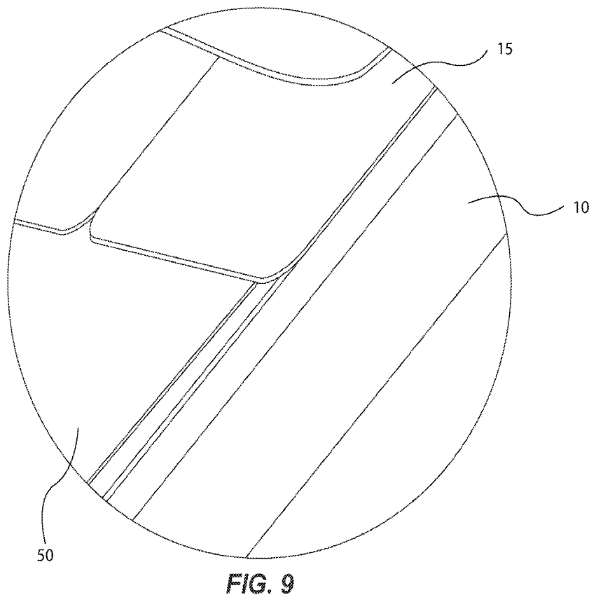

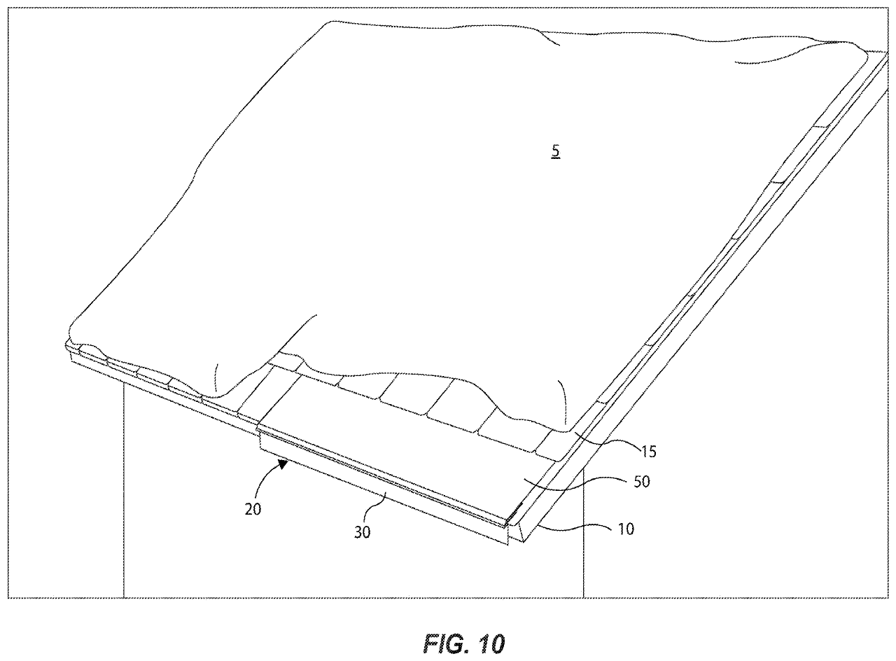

The terminal plate 50 features the same containment lip structure 53 as the middle plate, with its lower end folded over as an attachment insert 51 (FIG. 7). It does not feature an S-bend, but rather terminates at its upper edge 57. It interfaces with the middle plate in exactly the same manner as the middle plate 40 interfaces with the drip edge cover 30 (FIG. 8), which is to say that the attachment insert 51 is positioned in the middle plate's S-bend 45 and the containment lip 53 forms a chamber in combination with the body of the middle plate 40 for heat cable 60. It totally covers the anchor strip 47 of the middle plate and it, too, is fastened to the roof at its upper edge 57 and has its edge covered by shingles (FIG. 9). In so doing, each successive upper layer to the system protects the lower layers' attachment to the roof.

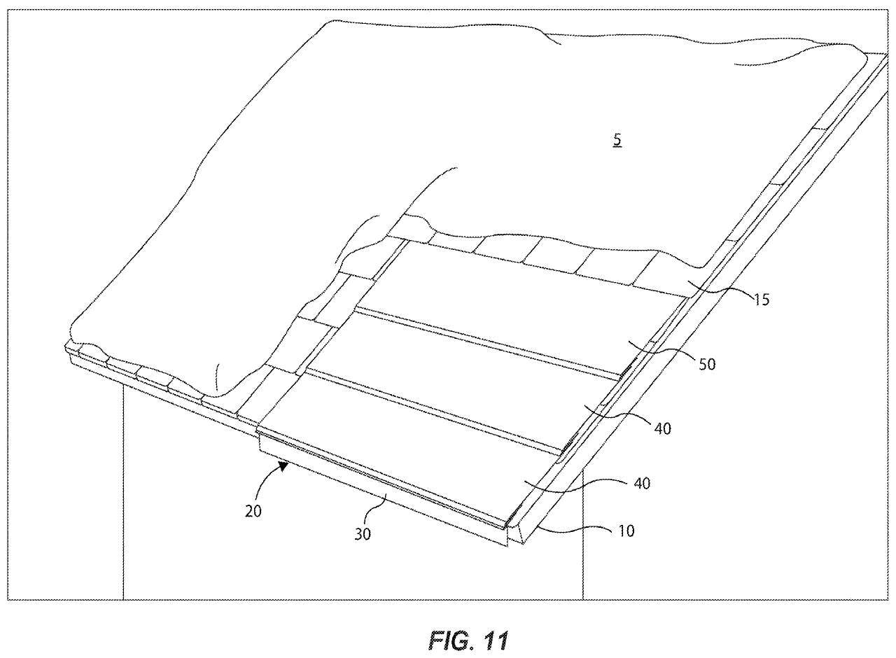

Variations to the system are possible. As can be seen in FIG. 10, the terminal plate 50 may be attached directly to the drip edge cover 30 or, as in FIG. 11, at least one additional middle plate may be added to the system. Since the attachment methodology is uniform with each plate, any number of middle plates may be utilized.

Metal alloys are the preferred material from which the plates and drip edge cover may be formed. Many metals are notorious for their thermal conductivity and their elastic and plastic deformation ranges are such that permanent bends, such as the S-bends and the containment lips, may be easily and permanently formed while the structure may retain enough elasticity so that the pieces may be locked together and hold the heat cables. The ideal dimensions of the individual plates will vary depending upon the actual material from which they are made and the intended roofing material. A length between 3-4 feet (0.9 -1.2 meters) provides good coverage while also being manageable for installation while smaller length plates may be utilized as caps for even coverage over a roof without cutting the plates.

It is ideal that the plates have enough width to cover at least one exposed shingle face (typically 6 inches) or a roofing tile (12 inches) and have some overlap to fit underneath the next higher row of roofing material. The width should be enough to cover at least one type of roofing material, if not two, and have some overlap with the other plates and/or adjacent roofing material row. The only other concern for a maximum width is that the plate will conduct heat throughout its entire width. Therefore, a width of 12 to 14 inches (0.30 to 0.35 meters) is currently recommended, but a width of as little as 6 inches (0.15 meters) could be utilized.

Heat cables 60 may be threaded through the space formed by the containment lips or may be positioned as each plate is installed. They may also be slipped under each lip, using the metal's elasticity to harmlessly create enough space for installation. Removal and replacement of the cable 60 may be accomplished by either pulling it out, or by slipping it under the lip as well. The elasticity of the metal allows the lips to contain heat cable 60 in one position in the system, allowing for uniform operation. The lips may also accommodate various sizes of cable, including cable slightly larger than the space allotted by the lip construction. It is ideal for at least some contact to be had between the plates and the cable, generally with more being more effective.

The Valley End Cap

The additional Valley End Cap invention comprises primarily a specially formed cap plate that integrates with the heated panel. Once the heat cable is installed into the heated panel systems, cap plates will be used to fill cavities and finish off the ends of the panels. The process of the installation of these cap plates customarily involves working from the bottom of the system to the top. The top plate will be installed on top of the first plate. The system can accommodate multiple rows and/or plates to conceal the cable appropriately.

The Valley End Cap embodiment is engineered, positioned, and designed to mount to the terminated cut end of a heated panel at a valley location and conceal the heated cable under the cap. The cap's unique positioning, engineering and design accommodates the heat cable in a transition flow moving from one panel to another. In the process of concealing the existing heat cable, this cap also accounts for snow and ice that may slide down the roof to flow over the top of the heated panel system. Previously, these locations exposed the heat cable and made it vulnerable to ice and snow damaging the cable. The instant cap method and apparatus devices address these issues.

In some embodiments, after the primary heated panels for the roof are installed, the heat cable is then inserted into the heated panels at the Valley locations. The heat cable therefore transitions from one horizontal heated-cavity to another horizontal heated-cavity.

At the transition point(s), the Valley Cap is then placed over the top of the heat cable's transition position. In some embodiments, the top side of the end cap slides into the cavity of the channel containing the heat cable. The side of the cap that intersects with the valley has an insertion lip that hooks into a C-fold (or appropriately formed “Ledger”) to hold the plate to the valley.

There is also a small fold on the bottom side of the plate that hooks to the lower edge of the heated panel. At this position-point, optional screws are placed to secure the panel to the roof. An optional additional end cap is then placed over the first end cap, therein integrating the edges of the plate to the heated panels and valley (similar to the first end cap position).

Advantages to the Valley Cap System include, but are not limited to:
1. The plate allows for the cable to be contained, preventing it from being exposed to elements and preventing additional damage from wind, snow, ice, or other factors that could damage the cable.
2. The plate is formed and positioned in such a way that it allows for the sliding of snow off the roof to pass over the top of it and not catch any exposed edges. This design and fabrication technique prevents snow and ice from pulling in any parts of the system and ripping it off the roof.
3. The positioning, engineering and design of the specialized plate(s) create(s) a low visual profile. Most previous products are unduly bulky. The herein-disclosed invention is low-profile and elegantly conceals into the roof system. The end result of the invention is a professional, clean looking roof.
4. The specialized plate may be comprised of standard sheet metal (or any appropriate metallic [or composite] material in a substantially sheet-form (e.g., Copper, Steel, Aluminum, alloys, or alternate appropriate materials/composites)).

The valley cap system may be comprised of Kynar™-clad sheet metal. It is designed to be integrated into the heated Panel System (by, inter alia, Wasatch Heat Cable™). The integration of the cap plate conceals and protects the heat Cable in the system. Applying the cap plate protects for the cable and the Plate System of the roof by providing a smooth surface for anything sliding from the top of the roof to the bottom of the roof to flow over the top of the components without catching any edges. The Valley Cap System is therefore low-profile, therefore being aesthetically appealing to higher-end Roof Systems.

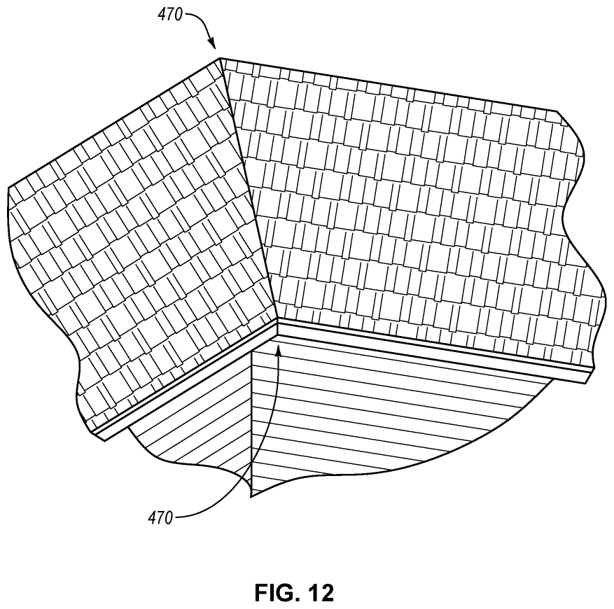

FIG. 12 shows a roof valley location 470 which requires the herein-disclosed invention. The positioning of the adjacent shingles at this location 470 requires the special feature (infra) which can cover this location while housing the cable 600.

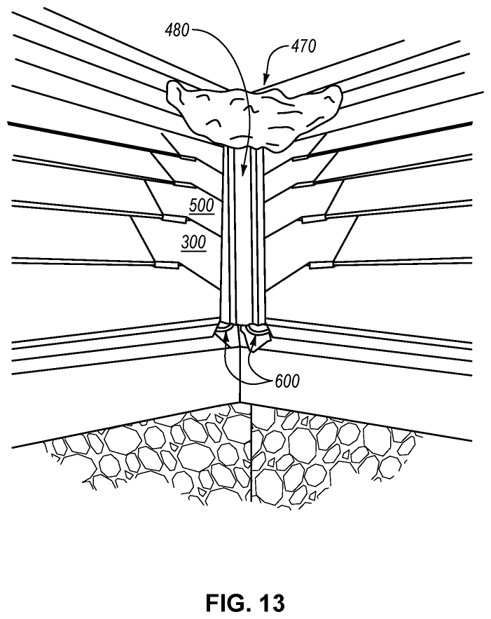

FIG. 13 is a front perspective view of the herein-disclosed invention substantially covering a roof valley location, illustrating substantially abutting/neighboring panels interconnected in-and-around a roof gutter, or “roof valley flashing” (with heating line 600 shown running into the base of the herein-disclosed “flashing plate” 480). The instant flashing plate runs between the “stacked” plates 300, 500 running vertically up each side of the roof. The flashing plate is tailored to cover the middle valley between these stacked plates 300, 500 (which cover their associated shingles and plates).

This middle structure, the roof valley flashing plate 480, is a special valley plate positioned in the roof's groove/valley. The valley flashing plate 480 comprises parallel channels running vertically (“longways,” as shown) such that that the cable 600 may go up and over (as shown on flashing plate 480 left side), or just run over and down (as shown on flashing plate 480 right side).

In a preferred embodiment, the flashing plate 480 is positioned in a roof valley 470, running substantially from the roof's top to its bottom. The flashing plate 480 comprises at least two substantially parallel channels, each channel having at least one entry/exit point.

Customarily, the heat cable 600 runs inside the flashing plate 480 at the roof valley location 470, and then the heating cable 600 exits the flashing plate 480 to enter another thermal panel 100/200 in a series/stacking fashion as shown in FIG. 13 and in FIG. 19. The cable may alternatively exit the flashing plate 480 and then run away from the roof's thermal panels 100,200 to ground or into a parapet or a rain gutter or another position.

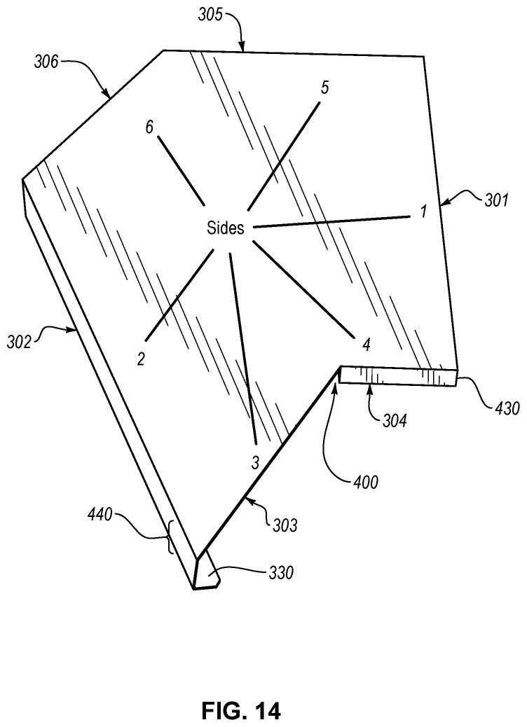

FIG. 14—Top view of Cap Plate
The cap plate 300 features six irregular sides designed to cover the cable at the Valley location 470. The plate 300 features a C-shaped bend 430 at the outer edge of the plate 300. The edge bend 430 therein forms an interlocking-capable edge 430, wherein the edge height 440 is substantially the same as the height differential 400 between panels (e.g., panel one 100 and panel two 200, shown in FIG. 14 as height differential 400. The elasticity of the sheet metal comprising plate One 300 and Plate Two 500 allows the necessary requisite slope bending to bridge this vertical plane distance 400). Copper-based plate material, or common sheet metal, or a composite thereof, allows this necessary elasticity.

In the preferred embodiment shown, Plate One's 300 Side One 301 features a “clean cut” with a [herein shown] vertical direction as to the plane of the roof. This side 301 overlaps atop the heated panel 100, therein allowing the system to “jump over” the Valley 470 (not shown in FIG. 14), therein allowing the Cable 600 to snake underneath (unencumbered by weather).

Plate One 300 Side Two 302 features an insertion lip 330, the inner surface of side two's C-bend 430 that hooks into the corresponding C-bend 430 of Plate Two 500, therein fitting into and covering the Valley 470.

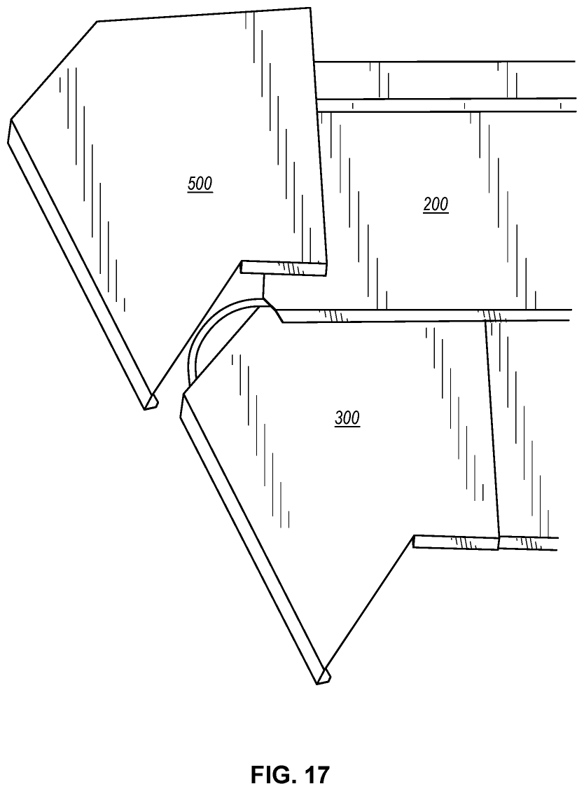

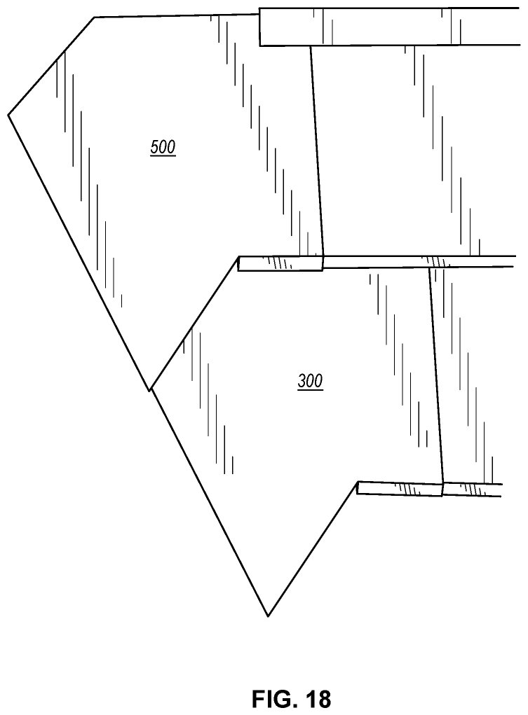

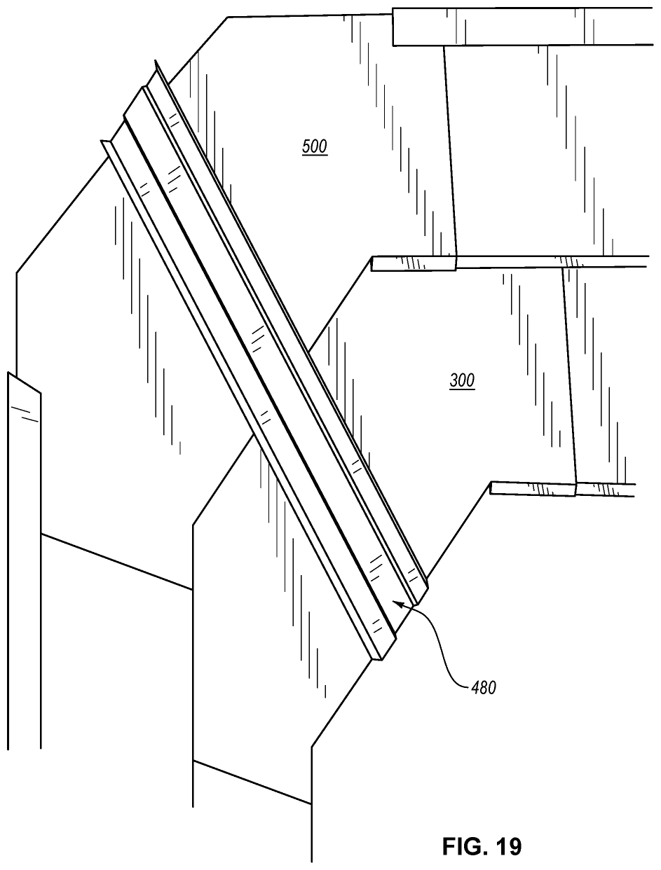

Plate One 300 Side Three 303 features a diagonal transition covering the heat cable 600, and transitions on top of the previous/next plate 500 (illustrated in FIGS. 17 and 18). The diagonal transition of Side Three 303 allows one plate to sufficiently bend over another plate to bridge the height gap 400 between the instant planes.

Plate 300 Edge Four 304 comprises an under-fold that hooks the bottom lip of the heated panel 100 (not shown), keeping the plate 300 secure to the panel 200 as shown in FIG. 16.

The Plate's 300 Fifth Side 305 herein shows the “top side” of the plate 300 that inserts between (and partially covers) the heated panels 100, 200 (not shown) and underneath the heat cable line 600 (which is covered by Panel Two 200, not shown).

Plate 300 Side Six 306 is a diagonal notch that allows the heat cable 600 to transition/jump from underneath the plate 300 and transition/jump to the top of the plate 300 towards its own plate-side-number-One 301 and into the heated panel 200 (not shown) system.

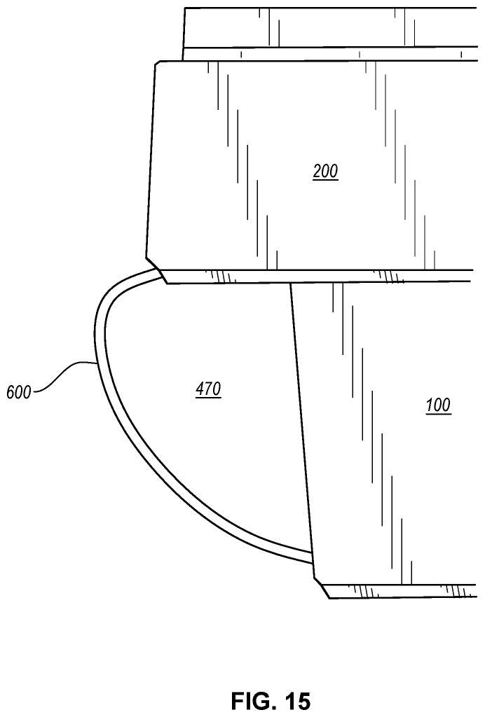

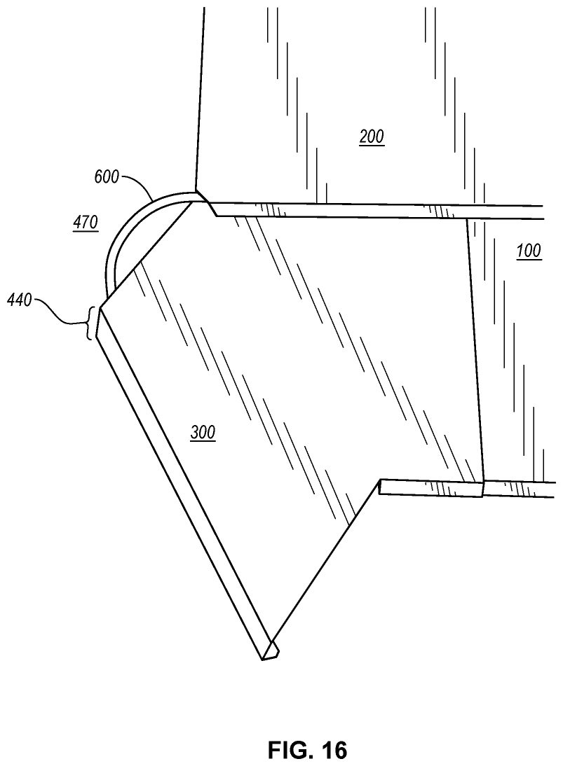

FIG. 15 Illustrates Two Heated Panels 100,200 with Heat Cable 600 Slightly Exposed over Valley 470. This Figure illustrates panel One 100 and panel Two 200 connected together with a joint. There is a line of heat cable 600 that transitions from the heat Trace cavity of panel One 100 up to the heat Trace cavity of panel Two 200 over the valley location 470.

FIG. 16—Valley Cap Plate covering Heat Cable on Panel One

FIG. 16 illustrates cap plate One 300 installed with the heat cable 600 transitioning from underneath the cap plate 300 on top of the panel one 100 running/jumping into the cavity 470 between panel one 100 and panel two 200. FIG. 16 illustrates the transition of the cable 600 from the cap plate 300 into the next panel 200.

FIG. 17—Attaching Cap Plate Two 500 atop previous (lower) Cap Plate One 200

FIG. 17 illustrates cap plate two 500 poised/ready to be installed over the top of cap plate one 300 and over panel two 200. In this process, cap plate two 500 will completely cover any exposed cable 600 that transitions off cap plate one 300 in the valley area 470.

FIG. 18—“As assembled/installed”—Both Cap Plates Atop Both Panels

FIG. 18 illustrates cap plate one 300 fully installed, as well as cap plate two 500, installed atop the top edge of “caps Light” number one.

This figure highlights the complete concealment of the heat Cable 600 inside the panel system, allowing the cable 600 to transition from one panel to another (safe from weather).
Note re: installation (not shown in this figure): After the installation of heated panel one 100 and panel two 200 along with the cable 600, the system will then be ready to have the Valley Cap plates 300,500 installed.

INSTALLATION: In the preferred embodiment, installing a cap plate (here Cap Plate One 300) would occur according to the following steps:

Plate one 300 Side Five 305 is inserted between the connecting joint of heated panel one 100 and heated panel two 200 underneath the heat tape line that runs between the two panels joints.

Plate One 300 Side Four 304 hooks onto the bottom of heated panel one 100.

Plate One 300 Side Two 302 inserts into the fold of the Valley Pan of the roof.

Plate two 500 Side three 503 covers the transition location of the previous plate 300.

Plate two 500 also features a C-shaped bend 430 at the outer edge of the plate 500. The edge bend 430 therein forms an interlocking-capable edge 430, wherein the edge height 440 is substantially the same as the edge height of Cap Plate One 300.

Note that the height differential 400 between panels (e.g., panel one 100 and panel two 200, shown in FIG. 18 as height differential 400) is necessarily covered by the elasticity of the sheet metal type material comprising Plate One 300 and Plate Two 500. The plate 500 material therefore allows the necessary requisite bend to bridge this vertical slope plane height differential 400.

Panel 500 side 504 overlaps atop heated panel two 200, therein allowing the system to “jump over” the Valley 470, therein allowing the Cable 600 to snake underneath plate two 500 (unencumbered by weather).

Plate Two 500 Side Two 502 similarly features an insertion lip 530 (inner surface of C-bend, herein not shown as it resides on the underside of Plate Two 500 Side Two 502). The inner surface of side two's 502's external C-bend 430 hooks into the corresponding C-bend 430 of Plate One 300, therein fitting into and covering the Valley 470.

FIG. 19 illustrates the invention “as assembled” over a roof valley location, herein showing the invention's ability to join-and-cover panels which are “abutting/adjacent” as well as “vertically stacked” up a roof. The plates on the left side of the roof's valley location (herein shown with a partial flashing cap immediately left of plates 300, 500).

Note that the additional “substantially mirror image” plates to the left of cap plates 300,500 illustrate how the instant roof “valley cap system” can cover valleys adjacent to and above/below already-installed-panels & plates, to cover a whole roof and all its valleys. Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A roof snow melt valley cap system comprising:
a length of heat cable running over a roof valley location;
a first thermally conductive roof panel having at least one edge;
wherein the panel's edge comprises a C-shaped bend of sufficient height to conceal the heat cable; and
a first six-sided cap plate covering a portion of the heat cable,
wherein at least one side of the cap plate has an edge folded into a C-shaped bend of about the same height as the panel's C-shaped bend; and
wherein the first cap plate interlocks with the first panel at the location of them C-shaped bended edges; and
a second thermally conductive roof panel placed substantially atop the first panel, the second panel having at least one edge comprising a C-shaped bend; and
a second six-sided cap plate wherein at least one side has an edge folded into a C-shaped bend of about the same height as the second panel's C-shaped bend;
wherein the second cap plate interlocks with the second panel at the location of their C-shaped bent edges; and
wherein the second cap plate fits over the first cap plate such that the remaining exposed portion of the heat cable is then covered.

2. The system of claim 1 wherein at least one cap plate is comprised substantially of sheet-metal material which is sufficiently flexible to bend over the thermal panel's C-shaped edge.

3. The system of claim 1 wherein at least one cap plate is comprised substantially of copper composite material which is sufficiently flexible to bend over the second panel's C-shaped edge.

4. The system of claim 1 wherein at least one cap plate is comprised substantially of aluminum composite material which is sufficiently flexible to bend over the second panel's C-shaped edge.

5. A roof snow melt valley cap system comprising:
a length of heat cable running over a roof valley location;
a first thermally conductive roof panel having at least one edge;
wherein the panel's edge is bent to conceal and house the heat cable; and
a first polygon-shaped cap plate covering a portion of the heat cable,
wherein at least one side of the cap plate has an edge folded into a substantially C-shaped bend,
wherein the first cap plate interlocks with the first panel such that the cable may run underneath both the panel and the cap plate, and
a second thermally conductive roof panel placed next to the first panel, wherein the second panel's edge is bent to conceal and house the heat cable,
a second polygon-shaped cap plate covering a portion of the heat cable,
wherein at least one side of the second cap plate has an edge folded into a substantially C-shaped bend of about the same height as the first cap plate's C-shaped bend;
such that the second cap plate interlocks with the first cap plate at the location of their C-shaped bent edges;
so, the interlocked cap plates cover any remaining exposed portion of the
heat cable.

6. The system of claim 5 wherein at least one cap plate is comprised substantially of sheet-metal material which is sufficiently flexible to bend over the other cap plate.

7. The system of claim 5 wherein at least one cap plate is comprised substantially of copper composite material which is sufficiently flexible to bend over the second cap plate.

8. The system of claim 5 wherein at least one cap plate is comprised substantially of copper composite material which is sufficiently flexible to bend over the second cap plate.

9. A Roof Valley Cap System comprising:
a roof with a top and a bottom;
said roof comprising shingles substantially covering the roof;
at least one thermally conductive roof panel substantially covering at least one shingle,
said panel concealing a heat cable,
said panel comprising at least one edge; and
at least one polygon-shaped cap plate covering a portion of the heat cable,
said cap plate comprising at least one edge;
wherein the roof panel and the cap plate interlock at their edges, and
at least one roof valley flashing plate positioned in a roof valley,
said flashing plate running substantially from the roof's top to its bottom;
said flashing plate comprising at least two substantially parallel channels,
each channel having at least one entry/exit point;
such that that the heat cable runs inside the flashing plate at the roof valley location, said cable then exiting the flashing plate.
